(19) United States
(12) Patent Application Publication
(10) Pub. No.: US 2004/0045413 A1
(43) Pub. Date: Mar. 11, 2004

(54) Device for screwing in fastening elements

(76) Inventor: Daniel Gasser, Diepoldsau (CH)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 10/466,157

(22) PCT Filed: Jan. 22, 2002
(86) PCT No.: PCT/EP02/00586

(30) Foreign Application Priority Data
Jan. 22, 2001 (DE) 101026900
Jan. 22, 2001 (DE) 101027036
Jan. 22, 2001 (DE) 101027052

(51) Int. Cl. B25B 13/00

(52) U.S. Cl. 81/52

(57) ABSTRACT

The invention relates to a device for screwing in fastening elements that consist of a plastic retainer (13) and a premounted screw (11). The inventive device is further characterized by a screwing device (6) and a screwdriver (5). The screwing device (6) comprises two tubular elements (58, 59) that are coaxially inserted one into the other. The extent to which they engage with each other can be adjusted and the tubular elements (58, 59) can be interlocked in the adjusted position. The tubular element (58) is further provided with a stop element (62) comprising a stop boss (63′) which interacts with a stop screw (63).

The invention relates to an apparatus of the kind defined in the preamble of patent claim 1.

In such an apparatus for setting fastening elements made of plastic holders and screws, it is indeed always possible to utilize equally long screws for bridging the widest possible region of different thicknesses of insulating material in attaching covering strips or plates. However, the length of the tubular extension of the plastic holder then varies accordingly. Given these different lengths of tubular extensions of the plastic holders, there also arises the need for different insertion techniques in order to enable the proper setting of the fastening elements. In the tubular extensions of various lengths the screw heads are inserted more or less deeply in these tubular extensions so that a drive shaft having a spike extending into the tubular extension has to be lowered different distances beyond the lower end of a wheelable base frame in order to be able to carry out complete driving in of the screw.

From (German Patent Publication) DE 200 07 656 U1, there is known an apparatus of the kind mentioned at the outset, in which the two tubular portions are slidable inside each other, specifically at most as far as permitted by a slot. By means of a height adjusting device, through choice of an appropriate hole for the insertion of a turnable screw, it can be predetermined how far one of the tube portions can be introduced vertically into the other tube portion during the screwing process. This depends on the length of a plastic holder to be attached. During the screwing in process the tubular portions are telescopically slidable inside each other. A boring machine used as screwdriver starts in each screwing in process at the same height. Only the path which the one tubular portion traverses, until an adjustment ring bears against the other stationary tube portion is adjustable. In the known apparatus, the height adjusting device is, essentially only a bottom abutment. This bottom abutment determines how far the one tubular portion can be moved downward by the drive shaft of the screwing device. By means of the height adjusting device one cannot determine how far the drive shaft projects from the screwing device at the bottom. But this is undesirable for tubular extensions of different lengths because these cannot be retained by the spike during the screwing in process. Therefore the plastic holder must be brought into the set position by external guiding devices.

Apparatuses of the initially described kind are known especially in connection with a wheelable base frame European Patent EP 0 600 285 A1. Normally the supply of the plastic holders takes place via a magazine. The plastic holders with screws which are normally already inserted are presented in a screwing in position co-oriented with the screwing in axis and are there grasped by the screwing device. By pushing down on the screwing device there then takes place the screwing in of the entire fastening element through penetration of the inserted screw into the substructure. However, it is always necessary to prevent turning of the plastic holder relative to the screwing device because it must be inserted in a precisely oriented position into the part to be screwed in, i.e. it must not turn together with the screwing device. For this purpose, there are normally provided relatively long guide shafts or guide tracks in order to protect the plastic holder from turning until the final setting of the fastening element. There can also be provided height adjustable, spring loaded pivotable jaws, which move in height along with the setting process and which remain applied until ultimate setting. Because of these measures, there are required especially costly structural means which also make it especially difficult to remove from the guide shaft or the guide tracks a plastic holder which for some reason becomes tilted.

Using a setting apparatus known from (European Patent Publication) EP 0 535 547 B1, fastening elements can not be screwed in which have a large area washer with a tubular extension made of plastic. The fastening elements for which the known setting apparatus is provided have a washer or a load distributor made of metal. This setting apparatus also does not have a holder for the fastening element which consists of a spike extending into a tubular extension of a plastic holder and located at the free end of the drive shaft. Instead, in this setting apparatus, there is provided a by-pass projection which acts to maintain the load distribution disk in place at a contact point of the load distributing disk next to a ramp. Thus, in this case, the holding device simultaneously serves to prevent turning.

The present invention has the object of providing a structurally simple and operationally problem-free adjustment device for fitting tubular extensions of various lengths on the plastic holders and providing an optimum holding arrangement and turning prevention for the plastic holders.

This object is achieved by an apparatus with the characteristics recited in patent claim 1.

By means of the inventive measures it is very simple to achieve that the spike which is to be introduced into the tubular extension, and which is also connected to the screwdriver via an appropriate drive shaft, can penetrate appropriately deeply into the tubular extension. Thus, through the mutual displacement of the tubular portions which extend coaxially within each other, compensation is achieved simply for tubular extensions of different lengths on the plastic holders.

To do so, there is provided in structurally simple manner at the outer tubular portion, a structurally simple spring loaded adjustable bolt, which extends into a radial hole in the inner tubular portion. This not only enables simple adjustment, but also secure locking and especially self-latching locking which remains securely in this locked condition until it is manually reopened.

In addition, it is proposed that the radial holes on the inner tubular portion follow each other with regular axial spacing. This makes possible a step-by-step adjustment, matching the regular dimensions of the tubular extensions of the plastic holders.

It is regarded as an especially desirable measure to provide the outer tubular portion with a bottom abutment which works together with a base frame. By these means the advancing movement of the plastic holder is always so adjusted that the large area washer of the plastic holder comes to bear directly on the surface of a strip to be attached. This creates the situation that, despite the simple adjustability for tubular extensions of different lengths, there is no need to simultaneously adjust the bottom abutment. Therefore the bottom abutment is always effective as a function of the ultimate setting of the plastic holder, whereas simple mutual displacement of the two coaxial tubular portions enables bridging of that dimension by which the screw head penetrates more or less far into a tubular extension of greater or lesser length.

Structurally simple provision is made for holding the spring loaded adjustable bolt in the bottom abutment. There is present here a corresponding accumulation of material so that sufficient guiding and resulting holding of the inserted spring loaded adjustable bolt becomes possible.

It is also advantageous to form the bottom abutment as a collar surrounding the outer tubular portion which receives the spring loaded adjustable bolt on one side and which has an abutment projection on the opposite side. Here, too, a functionally and structurally very simple solution can be provided whereby the adjustment can be carried out optimally and furthermore an appropriately stable abutment projection can be provided.

Optimum turning prevention can be achieved by providing the bolt which prevents the turning of the plastic holder at a projecting abutment surface on the free end of the screwing device and at the edge of the large area washer of the plastic holder serving as a turning preventing abutment.

By means of the spike which extends into the plastic holder there becomes possible precise axial orientation as known from (German Patent Publication) DE 197 54 356 A1, so that there is always assurance that the plastic holder and therefore also the screw inserted in the plastic holder, i.e. the complete fastening element, is oriented precisely along the screwing in axis. By means of the one or more bolts provided on the screwing device in accordance with the invention, precise orientation of the plastic holder about the screwing axis is further ensured in structurally simple fashion, which also makes it possible for this precise orientation to remain in effect until the ultimate setting of the fastening element. The turning prevention for the large area washer of the plastic holder therefore remains in effect until the ultimate setting of the fastening element.

By very simple but highly effective construction, the guide shafts or guide tracks heretofore required in such apparatus can be omitted along the entire displacement path of the screwing device. It is also not necessary to hold the large area washer of the plastic holder in place until ultimate setting using spring loaded jaws which can be swung out of the way or which can be pushed out of the way against spring loading, which also led to an expensive and space consuming structure. Simply by providing one or more freely projecting bolts, sufficient ability is provided for creating restraints against turning of the plastic holder.

This structure is equally effective whether the apparatus as a whole is used as a hand tool or is placed in a wheelable base frame. When used as a hand tool, the plastic holder is also oriented precisely coaxially with the spike and around the spike and is prevented from turning by the bolts functioning as restraints. Thus the same desirable results are achieved when applied to a hand tool as also when part of a wheelable base frame.

Overall, the inventive apparatus is substantially improved from the structural view point, it is simple to operate and makes possible especially good accessibility to all important parts. Even if there should occur irregularities in the supply of the fastening elements and especially of the plastic holders, manual intervention can be made without any problem because no interfering guides, shafts or enclosures are needed.

It is further proposed that the one or more bolts be located at a terminal edge of the abutment surface so that the one or more bolts prevent turning of an introduced plastic holder only at a longitudinal limit of the plastic holder. Therefore it is necessary to provide only turning prevention, and there is no need to provide suitable abutments or abutment areas at opposite longitudinal limits of the plastic holders, and much less such annularly closed devices. Indeed one such bolt would suffice but, by using at least two bolts, it can be ensured that the plastic holder can turn about the screwing axis neither in one nor in the opposite direction.

It is further proposed to make the length of the freely projecting bolts approximately equal to the thickness of the large area washer of the plastic holders in the corresponding abutment region. Because the plastic holder is supported on the free end of the abutting surface of the screwing device, a short bolt suffices to provide effective turning prevention for the plastic holder. Therefore, only a short length of these bolts is needed in order provide an abutment at the corresponding place, i.e. in the corresponding abutment region of the longitudinal limit of the washer.

Thus the apparatus according the invention is advantageously useable both as a hand tool and also as part of a wheelable base frame. In this regard it is advantageous if an apparatus is installed in a base frame and supplied with individual fastening elements with plastic holders, which are kept ready in a holder with appropriate orientation, wherein spring loaded jaws which can be swung out of the way are provided as lower support.

Specifically, when the device is used in a wheelable base frame, it becomes possible to preposition the fastening elements in appropriate orientation so that, during pushing down of the screwing device, the spike connected to the drive shaft penetrates into the plastic holder until the plastic holder comes to rest on the abutment surface at the free end of the screwing device. Because the plastic holders are kept ready in the holder with the appropriate orientation these plastic holders can be grasped at their longitudinal limit by the freely projecting bolts, at which time the screwing device itself takes over the function of preventing turning. During further downward movement of the screwing device, the spring loaded jaws are swung out of the way downwardly so that the plastic holder and the screwing device can pass further downward through this holding arrangement, up to the ultimate screwing in and setting of the fastening element. Thus, the holder serves mainly for the orderly keeping ready of the fastening elements because thereafter no additional guide rail or additional guide shaft is needed.

If, in an apparatus according to the invention, there is to be provided a simple way to securely hold the fastening element consisting of plastic holder and screw in the axial direction until the ultimate screwing in but, in so doing, enabling relative rotation between spike and plastic holder without creating frictional heat harmful to the plastic holder, then a device is proposed in which the spike has a body with a threaded bolt for attachment to the free end of a drive shaft, and in which there is applied to the body and the threaded bolt a tubular part for joint attachment to the body at the free end of the drive shaft, the restraining means taking the form of at least one protruding projection, which creates an axially secure hold, in cooperation with at least one annular, inwardly projecting bulge inside the tubular extension of a plastic holder.

This object is achieved by an apparatus with the characterizing features of patent claim 1.

By simply introducing the spike through pushing down on the screwing device or by applying a plastic holder to the screwing device, there can be achieved secure axial positioning of the plastic holder relative to the screwing device and this can be accomplished without applying significant force. Even if the annular inwardly projecting bulge formed in the plastic holder, which can also be present in multiples is annularly closed, easy insertion is required because only partial regions of the circumference of the spike need to pass beyond this bulge or bulges. Therefore, there is no need to provide an annularly closed widening of the tubular extension of the plastic holder in the region of the bead or beads, but there suffices, for example, a short one-sided bulge, because only the corresponding projection needs to be guided across the bead or beads.

In this regard, the (European Patent Publication) EP 0 783 063 A1 shows a cylindrical portion of a screwdriver. A screwing tip is inserted in the cylindrical portion. Annular ribs are provided in the plastic holder of a fastening element which is to be set, which are in clamping engagement with the cylindrical portion of the screwdriver. Thus the cylindrical portion of the screwdriver also serves for axial retention, but provided that the cylindrical portion of the screwdriver and the plastic holder rotate in unison. Otherwise undesired frictional heat would be created between the two.

This known apparatus is unsuitable for screwing in fastening elements when the plastic holder should not turn during screwing in, because the washer should maintain a predetermined orientation around the screwing axis until the ultimate setting of the fastening element.

In apparatus according to (German Patent Publication) DE 93 11 122 U1, the above-mentioned problems do not arise because this is intended for fastening elements which are hammered in.

In order to obtain orderly securing of the plastic holder to the spike and therefore to the screwing device, it is only necessary to keep the plastic holder from getting lost because, in the direction of removal of the plastic holder from the screwing device itself, there are no forces acting in this direction which could arise during setting or screwing in.

Frictional heating can not occur in use of the device according to the invention, because it provides no friction-creating attachment between plastic holder and spike, but rather a positive retention which readily permits mutual relative rotation.

A further special advantage of the apparatus according to the invention is that its spike can be attached to any screwing apparatus, in order to make this able to set fastening elements of the kind under discussion herein.

In this connection it is also especially advantageous if two diametrically opposite projecting protrusions are formed on the spike. Then, upon inserting the spike into the tubular extension of the plastic holder, the tubular extension in this region is deformed into an elliptical shape, whereas, after complete insertion of the protrusions, the tubular projection again returns to its original shape.

The insertion and orderly retention are improved even further by providing the projecting protrusions with an inlet ramp which extends at an acute angle to the screwing in axis, followed by an abutment which falls steeply away. This substantially facilitates the insertion process, even when inserting the plastic holder by hand and yet provides sufficient security against axially sliding displacement of the plastic holder.

Exemplary embodiments of the invention are described further in the description which follows with reference to the drawings. There are shown in:

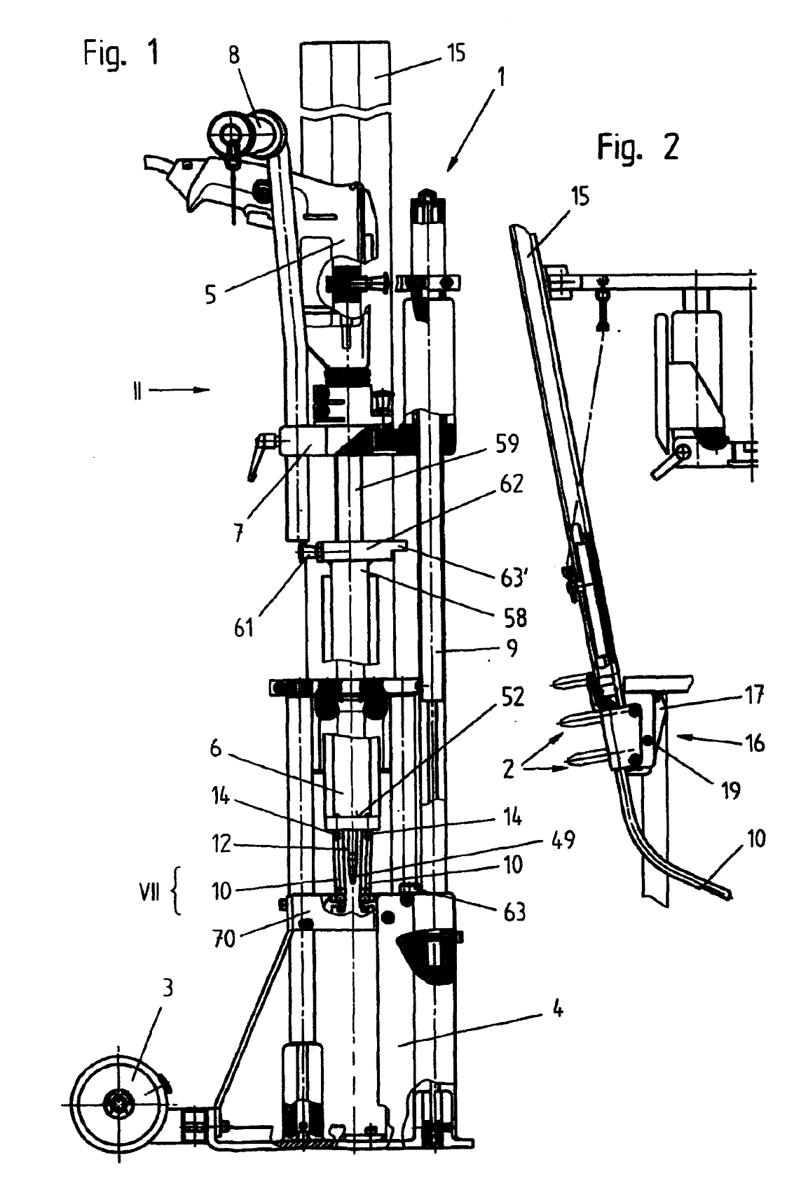

FIG. 1 a side view, partially in cross-section, of an apparatus for screwing in fastening elements pre-stored in a magazine;

FIG. 2 a side view of a portion of the apparatus of FIG. 1 viewed in the direction of arrow II;

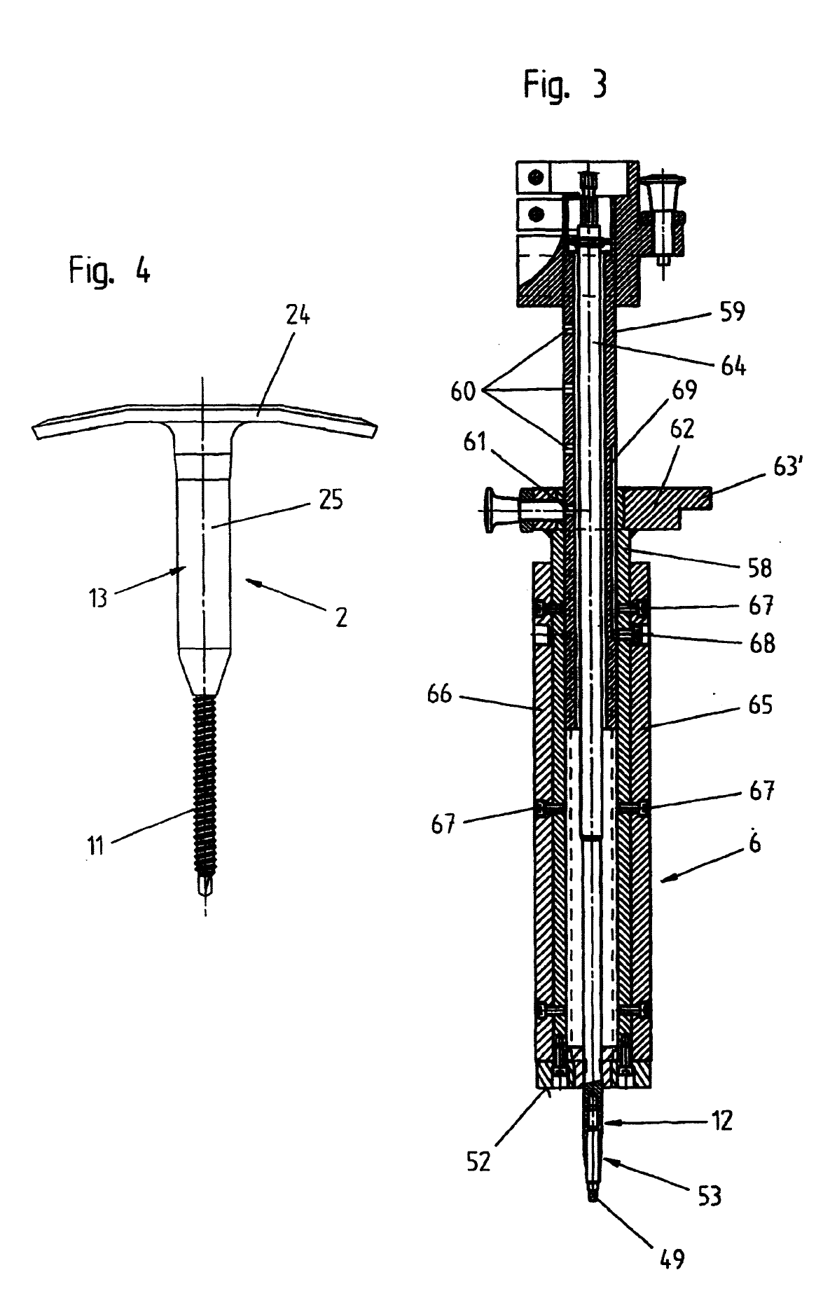

FIG. 3 a cross-section through a screwing apparatus not mounted on a base frame;

FIG. 4 a view of a fastening element insertable in the apparatus, and consisting of a plastic holder and a screw;

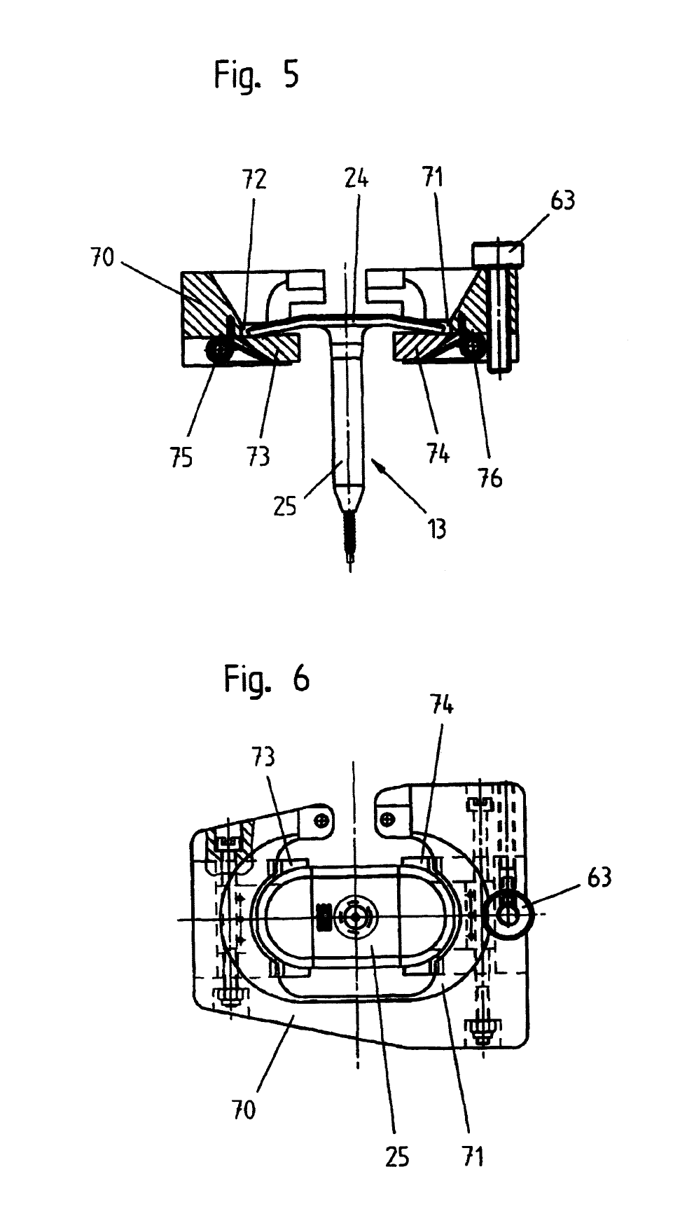

FIG. 5 a cross-section through a retaining means for keeping a fastening element in readiness;

FIG. 6 a top view of the retaining means according to FIG. 4;

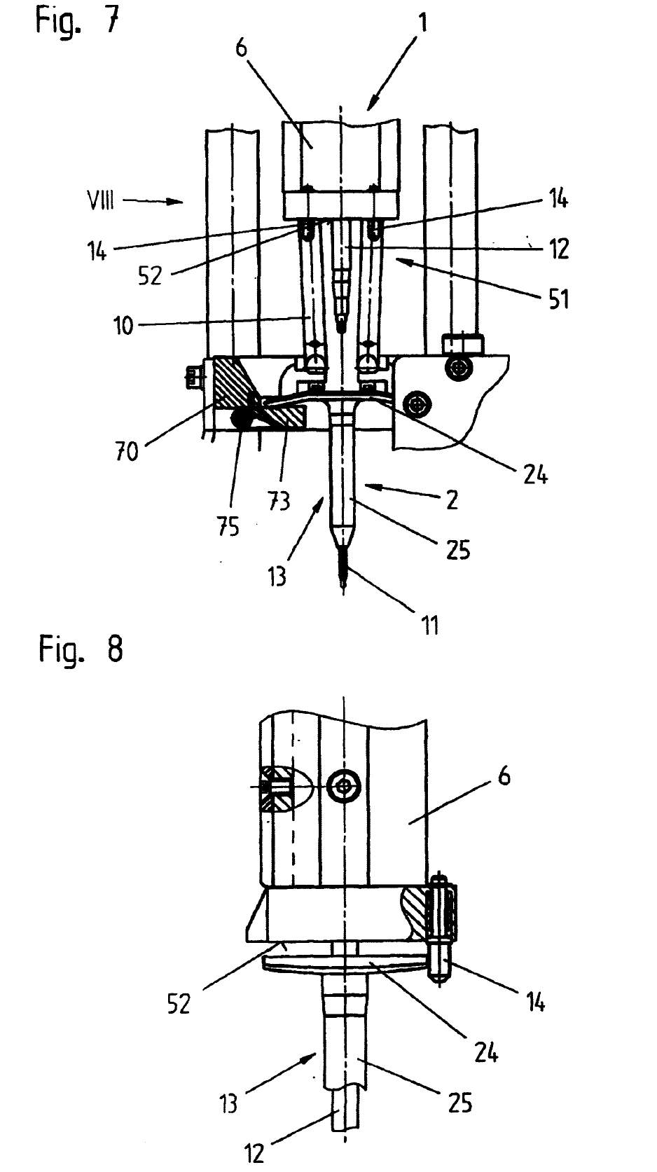

FIG. 7 an enlarged view of the portion VII in FIG. 1, shown partially in section, with fastening element inserted and held ready;

FIG. 8 a side view of the screwing device in the direction of arrow 8 in FIG. 7 shown partially in section;

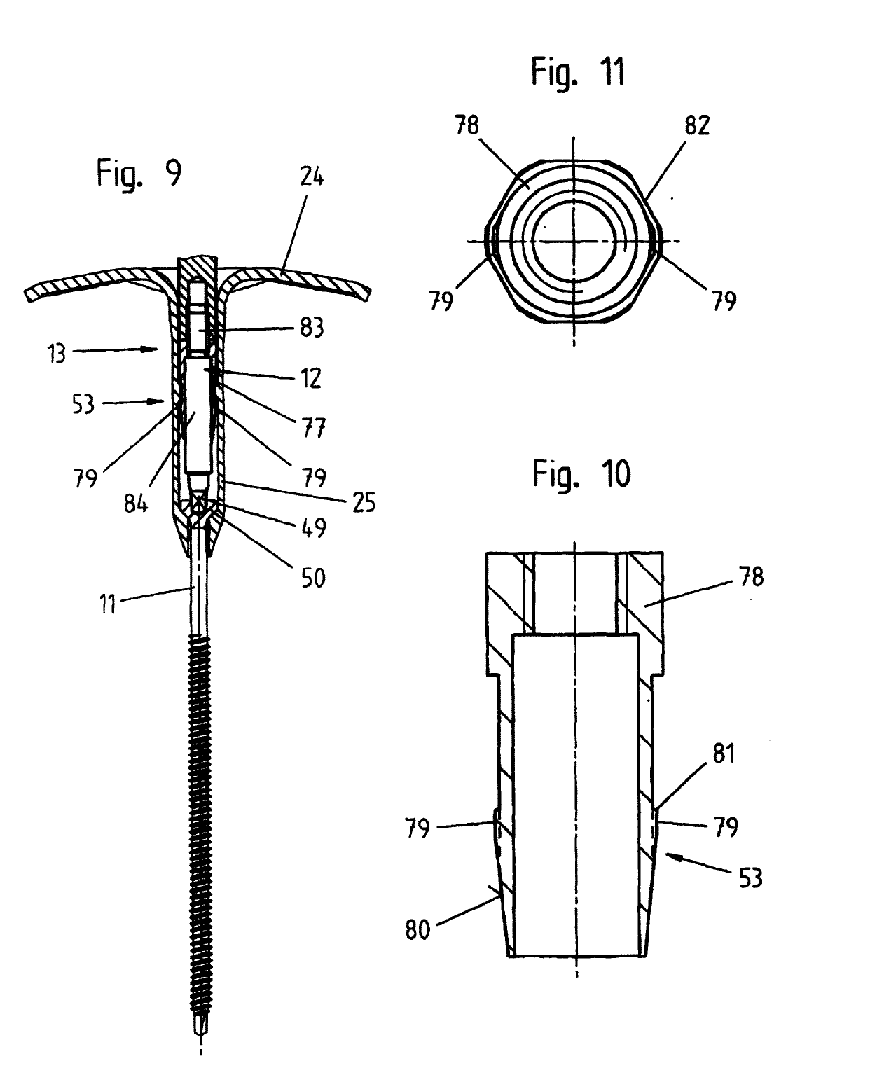

FIG. 9 the fastening element in side elevation, shown partially in section, wherein a spike connected to a drive shaft is inserted in the plastic holder;

FIG. 10 an enlarged representation of a partial segment of the spike in cross-section;

FIG. 11 a view of this partial segment from below.

In an apparatus 1 for screwing in fastening elements 2 kept ready in a magazine there exists a base frame 4 movable by means of wheels 3, in which there is retained a screwing device 6 with integrated screwdriver 5 displaceable in the vertical direction. The entire screwing device 6 is set in a mount 7 and therefore adapted to be handled by an operator via hand grips 8. The mount 7 is slidably retained via appropriate guide rails, the whole screwing device 6 being repeatedly self-propelled into the upper rest position by means of a gas actuated spring.

The fastening elements 2 are brought into the screwing in position via supply elements 10.

By pushing the screwing device 6 downward, a spike 12 provided with an attachment 49 for a screw 11 extends into the opening of a plastic holder 13 of the fastening element 2 far enough for the attachment 49 to grasp the screw head. Appropriate bolts 14 prevent the plastic holder 13 from turning during the pushing down of the fastening element 2 and during the screwing in process itself.

As can be seen from FIG. 4, by means of the apparatus 1 there are set the fastening elements 2, which consist of the plastic holder 13 and the preassembled screw 11.

Of course it would also be possible to supply the screw 11 only after the plastic holder 13 rests singly in the screwing in position. However, especially for such fastening elements made of plastic holder 13 and screw, it is advantageous and also appropriate for rapid setting, if the screw is already preassembled in the plastic holder and can also be supplied in this form via an available magazine 15. Between the magazine 15 and supply elements 10 which guide the plastic holder 13 toward the screwing in position, there is provided a single-unit picking apparatus 16, which assures that, during each setting process, i.e. by each pushing down of the screwing apparatus 6, one fastening element 2 is freed up and brought into the screwing in position. The single-unit picking apparatus 16 has a lever 17 which is swingable about an axis 19 that extends transversely to the supply direction from the magazine 15.

The screwing device 6, which also encompasses a pass-through drive shaft 64 provided at its free end with spike 12 having the attachment 49 and with restraining means 53 for holding back the plastic holder 13 in the axial direction, is specifically configured. The screwing device 6 consists of two tubular portions 58 and 59 which extend coaxially within each other, and corresponding mounting rails 65 and 66. The dimension of the mutually inserted parts of the two tubular portions 58 and 59 is adjustable, with the tubular portions 58, 59 also being mutually lockable in the selected arrangement. On the outer tubular portion 58, a spring loaded adjustable bolt 61 is provided. This bolt 61 extends into a radial hole 60 on the inner tubular portion 59. The inner tubular portion 59 is provided with several radial holes 60 which follow each other with a regular axial spacing so that it becomes possible to provide locking between the outer tubular portion 58 and the inner portion 59 at corresponding spacings. By sliding the two tubular portions 58 and 59 more or less far within each other, it follows that the spike 12 of drive shaft 64 extends more or less far beyond a lower bearing surface 52 of the screwing device 6 so that it becomes possible to match the various lengths of the tubular extensions 25 of plastic holders 13. It is as a function of the length of these tubular extensions 25 that spike 12 must be able to extend more or less deeply into the tubular extension 25 so as to reach the required setting depth with appropriate penetration into the head of screw 11.

Due to assembly considerations and also for stiffening of the screwing device 6, mounting rails 65 and 66 are provided at at least two opposite regions of the outer tube portion 58, which are firmly connected via screws 67 with the outer tube portion 58. Recessed in mounting rail 65 and screwed into the outer tube portion 58 there is further provided a screw 68 which engages a longitudinal slot 69 in the inner tube portion 59. This assures that the tubular portions 58, 59 cannot be completely pulled out of each other and furthermore mutual turning prevention is provided thereby.

On the outer tube portion 58 there is provided an abutment 62 which is used in conjunction with a base frame 4. Preferably, the spring loaded adjustable bolt 61 is held in this abutment 62. In the specific embodiment illustrated, the abutment 62 is configured as a strap surrounding the outer tube portion 58, which receives the spring loaded adjustable bolt 61 on one side and has a bearing projection 63′ on the opposite side. Thus, upon pushing down the apparatus 1, the abutment 62 and the abutment projection 63′ is also moved downwardly together with the screwing device 6 until it comes into contact with an abutment screw 63. Further advance of the screwing device 6 is then precluded. To carry out a fine adjustment of the bottom abutment, the abutment screw 63 can be turned farther outward or else from an intermediate position farther inward or outward so as to respectively create the optimum pressure by the large area washer of plastic holder 13 against a strip to be attached.

For the orderly retention of the fastening element 2 which is to be set by the apparatus 1 there is provided a retention device 51 which consists on the one hand of spike 12 formed at the free end of a drive shaft 64 and on the other hand of bolts 14. For precise co-orientation with the screwing in axis, spike 12 extends into the interior of the tubular extension 25 of plastic holder 13. There, spike 12 can grasp the head of screw 11 via the attachment 49. To prevent turning of the inserted plastic holder 13 there are provided, in the illustrated exemplary embodiment, two bolts 14 freely projecting from an abutment surface 52 formed at the free end of the screwing device 6. These bolts 14 operate as turning prevention abutment at the edge of a large area washer 24 of plastic holder 13. Two bolts 14 are provided in order to prevent turning of the washer 24 in both directions of rotation.

It is readily possible to provide only a single such bolt 14 or to provide a longitudinal abutment in place of a bolt. All that is required is to prevent turning of plastic holder 13, by means of abutments extending axially beyond the abutment surface 52 or by forming a single abutment. Of course, this can also be done in conjunction with a specific configuration of the peripheral shape of the large area washer 24 of plastic holder 13. For example, such bolts or other abutments can be matched to specific contours in the peripheral region of the washer or in relation to openings at the edge of or inside the washer. It is also possible-to provide at the opposite sides appropriate bolts 14 or similar abutments for the large area washer but for orderly retention it suffices to carry out such measures on one side only. In this connection it would also be possible to provide on abutment surface 52 of screwing device 6 a recess matching the shape of large area washer 24 which can receive the entire washer 24 or at least a part of it, so as to provide turning prevention in this manner. Thus it can be seen that there is possible not only the most effective and simplest construction, but that measures can also be taken which are structurally more complicated.

The length of the freely projecting bolts 14, or other corresponding abutment structures corresponds approximately to the thickness of the large area washer 24 of plastic holders 13 in the corresponding abutment region. Thus, there needs to be assurance that at least the edge of the large area washer 24 can be properly grasped by the bolts 14 at a longitudinal limit.

Especially in connection with the placement of apparatus 1 in a wheelable base frame 4, it is also desirable to prepare the fastening elements consisting of plastic holder 13 and premounted screw 11 appropriately for the screwing in process. For that purpose, a holding means 70 is provided on the base frame 4 which has an input region 71 which becomes narrower from the top toward the bottom. To this input region 71 there is connected an opening 72 which matches the contour of the large area washer 24. This opening 72 is closed off toward the bottom at two oppositely situated edge regions by jaws 73, 74. These jaws 73, 74 are provided with springs 75, 76 so that these jaws 73, 74 are shown in the closed position illustrated in FIG. 4, in their rest position beneath opening 72. As soon as a plastic holder 13 is introduced into the holding means 70, the screwing device 6 can be pushed downward. When the spike 12 then penetrates into the tubular extension 25 of the plastic holder 13 and the bolts 14 have grasped a lengthwise limit of large area washer 24, the entire screwing device 6 is pushed further downward so that the jaws 73, 74 can swing away downwardly against the force of springs 75, 76. From then on, the plastic holder 13 and with it the entire fastening element 2 is held exclusively by the screwing device 6 so that no additional guide shafts or guide tracks are needed. After return of the screwing device 6 following the end of the screwing in process the jaws 73, 74 are swung back into their initial position by the springs 75, 76 so that the holding means 70 is again ready to receive the next fastening element 2.

By means of the embodiment shown in FIGS. 9 to 11 there is now essentially achieved the axial retention of the fastening element 2, and especially of the plastic holder 13 until the ultimate setting of the fastening element 2. In so doing, it makes sense to not impede the screwing in process for the screw 11 through the axial retention of the plastic holder 13, or possibly to detract from the necessary turning-protected retention of the plastic holder 13. Further to be achieved is that the plastic holder 13 can be applied to the spike 12 simply and without great force exertion, i.e. optionally also by hand, in order to move into an axially secured position on this spike 12. Thus, when the plastic holder 13 is in position applied to the spike 12, no significant friction will be created upon mutual rotation.

The plastic holders 13 which are to be used here have, spaced from the large area washer 24 in the region of the tubular extension 25, a circumferentially closed bead 77 which, in the area of the tubular extension 25, creates, so to speak, a narrowed space. This bead 77, which also serves to prevent loss during premounting of the screws 11, namely when the head 50 of the screw can no longer be moved backwards across this bead 77, in the present case it is used for axial retention of the plastic holder 13 on spike 12. On spike 12, or on a separate detachable portion 78 of spike 12, there are present hold-back means 53 which form a sort of retainer arrangement 51 for retaining the plastic holder 13 in the direction of the screwing in axis. To this end, the hold-back means 53 take the form of at least one projecting protrusion 79, which provides assured axial retention in cooperation with the bead 77 which is formed inside the tubular extension 25 and which extends annularly inward.

Preferably spike 12 or portion 78 has two diametrically opposed projecting protrusions 79. To make it easier to slide the spike 12 and therefore the portion 78 into the interior of the tubular extension 25, the projecting protrusions 79 have an inlet ramp 80 extending at an acute angle to the screwing in axis and an abutment 81 which falls away steeply behind it. Thus, easy introduction is possible and with it easy reshaping of the tubular extension 25, whose cross-section is reshaped into a kind of ellipse during penetration by portion 78. As soon as the two mutually opposite protrusions 79 then leave the vicinity of bead 77, the tubular extension 25 again reverts to its original circular cross-sectional shape so that the bead 77 can engage portion 78 behind abutment 81. As soon as the protrusions 79 have passed over this bead 77, rotation of spike 12 in tubular extension 25 can again take place without appreciable impediment. Therefore, no particular effort is needed to produce rotation of plastic holder 13. Rather, there suffices the use of the two bolts 14 or corresponding other abutments, at the bottom abutment surface of the screwing device 6.

It is also readily possible to construct these protrusions 79 in another way. For example there could be provided such protrusions 79 respectively displaced by 90° from each other. It is also possible to extend these protrusions 79 respectively over predetermined circumferential portions, or to provide a circumferentially closed, protrusion-like strap. However, the introducing is then less easy to accomplish. In any case it is necessary to provide appropriate protrusions or a protrusion-like strap, in order to accomplish the engagement of a corresponding bead 77. If indeed only a cylinder-shaped part were used to frictionally engage the tubular extension 25 even if it had one or more beads 77, then there would always occur a correspondingly large friction between spike 12 and the interior of tubular extension 25, which is to be avoided in this situation.

From FIG. 11 it can also be seen that the upper segment of portion 78 forms a kind of hexagonal head. This provides in simple manner the possibility of screwing portion 78 onto the free end of drive shaft 64, thereby attaching to the drive shaft 64 the body 84 which bears the connection 49 and has a threaded bolt 83.

In FIGS. 5 and 6 it can be seen how the fastening element 2 and particularly the plastic holder 13 is kept ready when using the apparatus 1 in a wheelable base frame 4. A receptacle 7,0 is attached to the base frame 4, which has a narrowing input region 71 and an opening 72 connected thereto which matches the circumferential contour of the large area washer 24 of plastic holder 13. To close the bottom of this opening 72, jaws 73 and 74 are provided which are held in this position by springs 75 and 76. When, by pushing down the screwing device 6, the spike 12 has penetrated into the interior of the tubular extension 25 of plastic holder 13, and has there gone past the bead 76, there promptly ensues appropriate axial retention of the fastening element 2, with two bolts 14 being elliptical at a longitudinal limit of the large area washer 24. Upon further pushing down the two jaws 73 and 74 are pushed downwardly against the force of springs 75 and 76, whereupon the fastening element 2 is held only by the axial retention between spike 12 and tubular extension 25 and the radial retention by abutment at bolts 14.

The measures used in accordance with the invention for the axially secure retention of a plastic holder can be used in an apparatus which is utilized as a hand tool or else in an arrangement in which the apparatus is part of a wheelable base frame. Likewise such a structural embodiment can be used for supplying plastic holders, i.e. in a kind of magazine. In that case, each time that a fastening element is made ready, the spike used exclusively for magazine operation would have to be pulled out again. However, it would also be possible to utilize such a spike for withdrawing a fastening element from magazine storage, in which case the fastening elements would have to be guided all the way to spike 12, or the spike 12 itself would have to be pivoted from a withdrawal position into a screwing in position.

What is claimed is:

1. Apparatus for screwing in fastening elements which consist of a large area washer and a tubular extension forming a plastic holder and a premounted screw, a screwing device and a holding device being provided for the fastening element and the screwing apparatus being driven by a screwdriver and consisting of two tubular portions extending coaxially within each other,
characterized in that the holding device includes a spike (12) actuatable by the screwing device (6) which extends into the tubular extension (25) of a plastic holder (13) and effects axial retention of the plastic holder (13) and in that the degree of the mutually inserted parts of the two tubular portions (58, 59) is preadjustable depending on the length of the tubular extension (25) and in that the tubular portions (58, 59) are mutually lockable in the preadjusted state, so that the spike (12) extends more or less far beyond a lower abutment surface (52) of the screwing device (6).

2. Apparatus according to claim 1, characterized in that a spring loaded adjustable bolt (61) is located at the outer tubular portion (58, 59) which engages radial holes (60) formed on the inner tubular portion (59).

3. Apparatus according to claim 2 characterized in that radial holes (60) on the inner tubular portion (59) follow each other at a regular axial spacing.

4. Apparatus according to one of claims 1 to 3, characterized in that the outer tubular portion (58) is provided with a bottom abutment (62) which functions upon use in conjunction with a base frame (4).

5. Apparatus according to claim 4, characterized in that the spring loaded adjustable bolt (61) is retained in the bottom abutment (62).

6. Apparatus according to claim 5, characterized in that the bottom abutment (62) takes the form of a strap encircling the outer tubular portion (58) which receives the spring loaded adjustable bolt (61) on one side and has a projecting abutment (63′) on the opposite side.

7. Apparatus according to one of claims 1 to 6, in which there is provided turning prevention for the plastic holder which is formed of at least one bolt characterized in that the turning prevention forming bolt (14) for the plastic holder (13) is provided freely projecting at an abutment surface (52) at the free end of the screwing device (6) and functions at the edge of the large surface washer (24) of the plastic holder (13) as an abutment which prevents turning.

8. Apparatus according to claim 7, characterized in that the one or more bolts (14) are located at an outer edge of the abutment surface (52), the bolts (14) being operative for turning prevention of a supplied plastic holder (13) only at a longitudinal end of the plastic holder (13).

9. Apparatus according to claim 7 or 8, characterized in that the length of the freely projecting bolt (14) is approximately equal to the thickness of the large area washer (24) formed in the appropriate abutment region of the plastic holders (13).

10. Apparatus according to one of claims 1 to 9, wherein the retaining means (51) is provided for orienting the fastening element (2) in the screwing in axis and is formed at a spike (12) engaged in the plastic holder (13), wherein the screwing device (6) has an abutment, which prevents turning of the plastic holder (13) during the screwing in process, wherein the spike (12) has a body (84) with a threaded bolt (83) for attachment to the free end of a drive shaft (64) and wherein there is applied to the body (84) and to the threaded bolt (83) a tubular part (78) for combined attachment to the body (84) at the free end of the drive shaft (64), wherein the retaining means (53) has the shape of at least one projecting protrusion (79) which cooperates with at least one bead (77) formed inside the tubular extension (25) of a plastic holder (13) and projecting inwardly to provide axially secure retention.

11. Apparatus according to claim 10, characterized in that, on the tubular part (78) of the spike (12) there are formed two diametrically oppositely located projecting protrusions (79).

12. Apparatus according to claim 10 or 11, characterized in that the projecting protrusions (79) have an inlet ramp (80) which extends at an acute angle to the screwing in axis and an abutment which falls off steeply to the rear.
